(19) United States
(12) Patent Application Publication
(10) Pub. No.: US 2006/0251775 A1
(43) Pub. Date: Nov. 9, 2006

(54) Edible watercolors and methods of making edible decorations

(75) Inventors: Kathryn E. Anderson, Tacoma, WA (US); Mimi Fielding, Gig Harbor, WA (US)

Correspondence Address: STOEL RIVES LLP, 900 SW FIFTH AVENUE, SUITE 2600, PORTLAND, OR, 97204-1268, US

(73) Assignee: The Lucks Company, Seattle, WA (US)

(21) Appl. No.: 11/122,787

(22) Filed: May 3, 2005

(51) Int. Cl. A23G 3/28

(52) U.S. Cl. 426/383

(57) ABSTRACT

A palette of solid edible paints is formed by mixing quantities of an edible fluid medium with one or more edible colorants to make edible fluid paints of assorted hues; arranging deposits of the various hues of edible fluid paints on one or more carrier substrates; and drying the deposits of edible fluid paints until solid. Thereafter, the deposits of solid edible paint may be wetted to thereby dissolve or disintegrate at least a portion of the edible paint that can be transferred onto an article using a transfer applicator such as a swab or brush, to thereby make an edible decoration. The palette may be packaged in a convenient decorating kit, together with one or more edible decorating sheets and one or more transfer applicators.

### COPYRIGHT NOTICE

©2005 The Lucks Company. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This application relates generally to food decorating and, in particular, to decorating methods, edible paint compositions, and kits for creating edible decorations, especially on food items.

### BACKGROUND

U.S. Pat. No. 5,017,394 of Macpherson et al. (“the '394 patent”), which is incorporated herein by reference, describes an edible decorating sheet (referred to in the '394 patent as a “base shape material”) on which images can be printed for decorating foodstuffs. Pre-printed edible decorating sheets are made and sold by the assignee of the present invention under the trademark EDIBLE IMAGE®. The EDIBLE IMAGE® product provides the food decorating industry with an efficient means of applying a high-quality image onto a food item such as a frosted cake.

The edible base shape material is produced, as further described in the '394 patent, by a screen casting technique that results in a thin homogenous sheet of edible, flexible, freestanding material removably adhered to a backing sheet. An exposed outer surface of the base shape material opposite the backing sheet is printed upon using edible inks to produce a finished decoration. The foodstuff may then be decorated by simply removing the finished decoration from the backing sheet and applying the decoration onto the foodstuff. When decorating a cake, the decoration is typically applied over icing.

As described in the '394 patent, a high-definition image can be created on the edible base shape material using flowable edible inks, applied using a screen printing technique. The '394 patent describes equipment suitable for such purposes, which is similar to conventional screen printing systems used for inedible inks. Such equipment is relatively efficient for high-volume production, but too specialized and expensive for retail bakery use or home use.

Digital edible-ink printing systems such as thermal ink jet printers, piezo-electric printers, and other computer-controlled printing devices (hereinafter “digital printers”) are known for use by bakeries to print images on blank sheets of base shape material. Digital printers also allow custom images, digital photographs, and decorations to be selected or prepared by the customer and to be printed onto blank edible decorating sheets at a bakery on an as-needed basis. However, the digital printers and special edible ink cartridges used in such systems are generally too inconvenient and expensive for home use.

U.S. Pat. No. 6,616,958 of Stewart discloses edible decorating kits including blank or pre-printed sheets of reinforced edible film packaged together with a set of felt-tip marker pens filled with assorted colors of edible ink. The marker pens are provided for drawing edible decorations on the edible film, which can thereafter be used to decorate a foodstuff such as a cake.

The present inventors have recognized that even felt-tip edible ink marker pens are relatively expensive for occasional home use and wasteful, as only a small amount of food decorating is typically done on any one occasion, whereas such marker pens contain enough edible ink to complete many projects. Edible ink marker pens are also bulky, difficult to package with certain foods, and include liquid ink compositions that may have limited shelf-life or require refrigeration. Furthermore, the marks created by edible marker pens are of limited size and color characteristics. For example, the present inventors have recognized that different hues of edible markers cannot be blended and their color values cannot be diluted to produce a painterly effect of the kind realizable with conventional inedible paints, and particularly by conventional watercolors.

The inventors have recognized a need for improved food decorating methods, systems, and compositions.

### SUMMARY

A method of making an edible decoration includes forming a palette comprising a set of solid edible paints supported on one or more carrier substrates. The set of solid edible paints is formed by mixing quantities of an edible fluid medium with one or more edible colorants to make edible fluid paints of assorted hues; arranging deposits of the various hues of edible fluid paints on one or more carrier substrates; and drying the deposits of edible fluid paints until solid. Thereafter, the deposits of solid edible paint may be wetted to thereby dissolve at least a portion of the edible paint. A transfer applicator can be used to transfer dissolved edible paint from the palette to an article to be decorated, where the edible paints may complete an edible decoration.

Edible decorating kits according to preferred embodiments include one or more palettes of solid edible paints, which may be packaged in a sealed bag or other container together with one or more edible decorating sheets and one or more transfer applicators. Edible decorating sheets of edible decorating kits may optionally include pre-printed designs or other markings intended to be decorated using the set of edible paints.

Additional aspects and advantages will be apparent from the following detailed description of preferred embodiments, which proceeds with reference to the accompanying drawings.

### BRIEF DESCRIPTION OF THE DRAWINGS

FIG. 1A shows a palette of edible watercolors supported on a carrier substrate, with spots of the edible watercolors partially dissolved by a wetted swab according to a preferred embodiment;

FIG. 1B shows palettes of edible watercolors in various shapes, each palette being supported on a carrier substrate, in accordance with alternative embodiments;

FIG. 2 shows an edible decorating sheet pre-printed with a picture outline;

FIG. 3 shows the edible decorating sheet of FIG. 2 after painting with the edible watercolors of FIG. 1A;

FIGS. 4 and 5 show a finished decoration of the painted edible decorating sheet of FIG. 3 being peeled from its backing sheet and applied to an iced cake, respectively; and

FIG. 6 shows a decorating kit including palettes of edible watercolors, edible decorating sheets, and transfer applicators.

### DETAILED DESCRIPTION

In accordance with preferred embodiments described herein, a palette comprising a set of solid edible paints is formed by mixing quantities of an edible fluid medium with one or more edible colorants to make edible fluid paints of assorted hues; depositing onto one or more carrier substrates spots of the various hues of edible fluid paints; and drying the spots of edible fluid paints until solid. In one embodiment, the spots of edible fluid paint are deposited on a common carrier substrate by a screen casting technique in one or more screen casting steps. Alternatively, other methods of deposition may be used. The deposited spots of edible fluid paints are preferably dried until consolidated and sufficiently firm to substantially withstand smearing, but not so dry as to crack or disintegrate.

The edible fluid medium is preferably water-based so that the spots of solid edible paint of the palette are readily soluble in water and thereafter paintable onto an article using a wetted transfer applicator, such as a brush or cotton swab, for example. The edible colorants are also preferably water-soluble and may include water-soluble dyes, such as FD&C-certified dye powders, that readily dissolve in the edible fluid medium. Advantageously, water-soluble edible paints—referred to herein as edible watercolors—may be used to create decorations having a truly painterly appearance, including graduated hues and color values.

In some embodiments, the edible fluid medium includes a substantial amount of a food-grade humectant additive, such as glycerine, to help maintain a water content sufficient to prevent cracking and disintegration after the edible paints have been dried. Embodiments of the edible fluid medium may also include an emulsifier, such as polyglycerol esters of fatty acids or polysorbate 60, to promote surface adherence on the carrier substrate. In still other embodiments, the edible fluid medium may include a mixture of a starch, a gum, a sugar, an emulsifier, and a food-grade humectant additive. Each spot of edible paint may also include a flavoring or a scent additive corresponding to its hue.

Thus, methods according to preferred embodiments further include wetting at least one of the spots of solid edible paint to thereby dissolve at least a portion of the edible paint; contacting a transfer applicator to the dissolved edible paint, to thereby load the transfer applicator with the edible paint; and contacting an article with the loaded transfer applicator, to thereby form an edible decoration with the edible paint. In preferred embodiments, a wetted transfer applicator such as a paintbrush or cotton swab is rubbed against one or more of the spots of solid edible paint to dissolve the edible paint and load the transfer applicator in one step, in the familiar manner of a conventional child's watercolors set.

The palette of solid edible paints may be packaged as a kit in a sealed bag or other container. So packaged, the palette advantageously has an exceptionally good shelf-life of at least six months, and preferably several years or more, without requiring refrigeration. The kit may conveniently include a transfer applicator, such as a cotton swab or brush, for example. The kit may also optionally include one or more edible decorating sheets, such as PRINT-ONS® or EDIBLE IMAGE® brand decorating sheets, adapted to receive and carry a decoration created with the water-soluble edible paints. The edible decorating sheets of the kit may be either blank or pre-printed with a picture outline or other design or text for enhancing the decorating experience. After applying edible watercolors to one of the edible decorating sheets to form a decoration thereon, a flexible backing sheet supporting the edible decorating sheet may be peeled away and the edible decorating sheet then applied to a food item, such as an iced cake or cookie, for example.

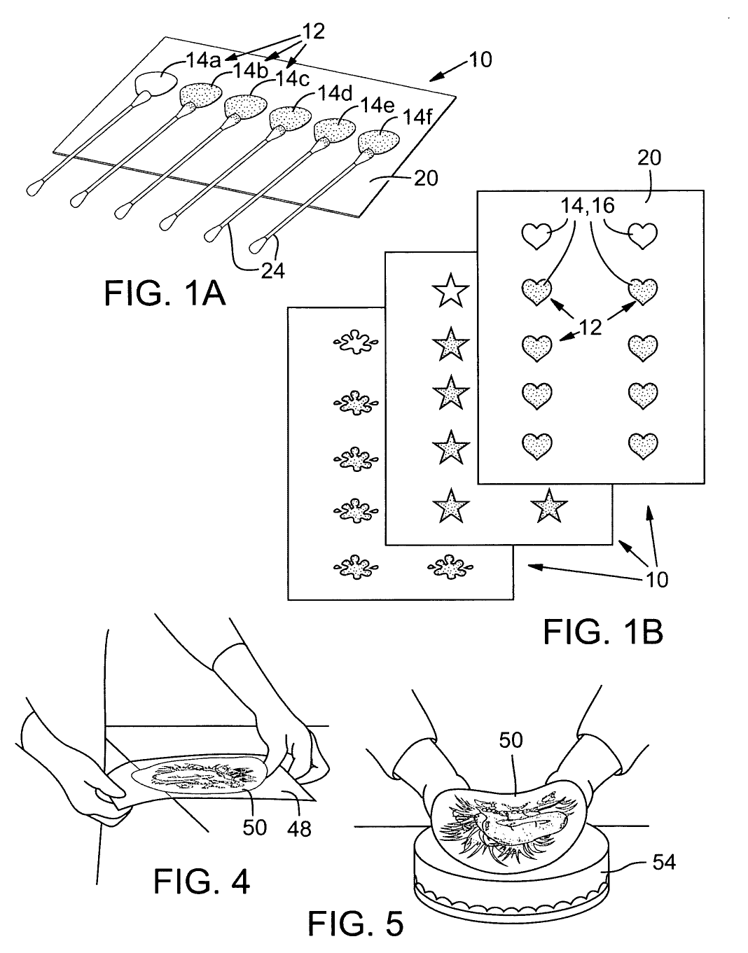

FIG. 1A shows a palette 10 including a set of edible watercolors 12 according to a preferred embodiment. FIG. 1B shows alternative embodiments of palette 10, including edible watercolors 12 formed in various shapes. With reference to FIGS. 1A and 1B, each of the sets of edible watercolors 12 includes a plurality of spots 14 of solid edible paint 16 in an assortment of hues (labeled 14a-f in FIG. 1A), supported on and adhered to a carrier substrate 20. The solid edible paints 16 are easily dissolved with water and may be painted onto another article using a wetted transfer applicator 24, such as a paintbrush or cotton swab. Each set of edible watercolors 12 may include different hues, intensities, or saturations of edible paint. A set of six different hues, including violet 14a, blue 14b, green 14c, yellow 14d, orange 14e, and red 14f, provides a basic color palette of the primary and secondary colors, from which various other hues may be created by mixing dissolved portions of selected spots 14a-f. Color mixing may be accomplished on the surface of carrier substrate 20, on a transfer applicator 24, or on the surface of an article being decorated.

The method of making spots 14, described below, enables spots 14 to be formed in various shapes, such as circles, stars, swirls, hearts, splashes, paw prints, and many other fun and interesting shapes, some of which are shown in FIGS. 1A and 1B. In some embodiments, spots 14 are formed in regular shapes (e.g., circles, hearts, stars, etc.), while other embodiments may include irregular shapes, such as splashes, smiley-faces, paw prints, and silhouettes, for example. In yet another embodiment, the spots 14 may be formed in the shape of a trademark symbol or logo, to provide a unique marketing opportunity. In still another embodiment (not shown), the shape of each of the spots 14a-f may correspond to its hue, providing a further dimension to the edible watercolors 12 that may be educational for small children. For example, a spot of violet hue 14a, may be shaped as a bunch of grapes, a spot of yellow hue 14d as a lemon, a spot of orange hue 14e as an orange or carrot, etc. Each of the spots 14a-f may also be flavored and/or scented, so that the flavor and/or scent of each spot 14 on a palette 10 corresponds to its hue, providing additional play value and educational value. Exemplary natural flavor and/or edible scent additives include natural orange flavor, natural lemon flavor, anise, peppermint extract, vanilla extract, essential oils, and flavored oils in a wide variety of flavors. Many artificial flavorings and/or edible scent additives are also commercially available.

Each of the spots 14 of solid edible paints 16 is formed from a mixture of an edible fluid medium and one or more edible colorants that is deposited onto the carrier substrate 20 and dried in-situ until sufficiently firm to resist smearing. Suitable carrier substrates 20 include food-grade polymer coated papers, plastic carrier trays, plastic films, and other food grade substrates, preferably waterproof or water-resistant. The edible fluid medium is preferably water-based and the spots 14 of solid edible paint 16 are readily soluble or suspendable in water and thereafter transferable to another article using a wetted transfer applicator 24. The edible fluid medium is preferably comprised of ingredients that are predominantly white or colorless and result in a mixture having a somewhat acidic pH so that the edible fluid medium will have a reasonable shelf life. For example, the edible fluid medium may have a pH of between approximately 3 and 8, and more desirably between approximately 4 and 7, to provide a shelf life of approximately seven days or more. However, the edible fluid medium is preferably not so acidic or alkaline that it would significantly change the hue or color value of edible colorants mixed therewith, i.e., it would have no significant effect on color stability. Table 1, below, sets forth ingredients and ranges of their quantities used for embodiments of the edible fluid medium.

TABLE 1
Edible fluid media formulation

| Ingredient | | Weight (kg) |
|---|---|---|
| 1. | Starch (tapioca, corn starch, or other starch) | 18-24 |
| 2. | Microcrystalline cellulose | 0-12 |
| 3. | Corn syrup solids (or corn syrup, or maltodextrose) | 18-24 |
| 4. | Gum or alginate (sodium alginate, xanthan gum, or | 0-0.5 |
| | other gum or alginate) | |
| 5. | Water (90-100° F.) | 35-40 |
| 6. | Citric acid | 0-0.1 |
| 7. | Potassium sorbate (or other preservative) | 0-0.1 |
| 8. | Sugar (invert sugar or other sugar) | 2.8-4.0 |
| 9. | Humectant additive (glycerine, propylene glycol, | 2.0-2.6 |
| | sorbitol, or other humectant) | |
| 10. | Emulsifier (polyglycerol esters of fatty acids, | 0.6-1.5 |
| | polysorbate 60, polysorbate 80, or other emulsifier) | |

The starch (ingredient #1) may include tapioca, corn starch, potato starch, rice starch, wheat starch, or any other suitable food starch. In the preferred embodiment, starch serves as a filler and color carrier. It is inexpensive, bland tasting, and white, and enables the solid edible paint 16 to disintegrate rapidly when wetted.

A preferred microcrystalline cellulose (MCC) (ingredient #2) is AVICEL PH 105™ sold by FMC Corporation. One alternative is an MCC gel. The MCC provides toughness to the solid edible paint 16, enabling it to flex without cracking. The MCC is also bland and white, and enables the solid edible paint 16 to disintegrate rapidly when wetted.

The corn syrup solids, preferably 42 DE (dextrose equivalent), corn syrup, or maltodextrins, are an economical filler and color carrier. They are bland flavored, have moderate sweetness, and advantageously function as film formers and binders. The corn syrup solids (or alternatives) help maintain a desired moisture content of the solid edible paint 16 so that it is not brittle or gummy.

The sugar, preferably invert sugar or other liquid sugar, provides sweetness, strength, and elasticity to the solid edible paint 16. The sugar is also white and may also help with moisture retention.

The humectant additive helps retain moisture and is preferably a plasticizer that helps prevent the solid edible paint from becoming brittle. It is preferably bland, slightly sweet, and clear.

The emulsifier provides surface active properties to the wet edible paint, enhancing its ability to adhere uniformly to the substrate during printing and drying. One preferred emulsifier is polyglycerol esters of fatty acids sold under the trade name LUMULSE PGO™ by Lambent Technologies, and more preferably LUMULSE PGO with a hydrophilic lipid balance (HLB) of approximately 13. Alternative emulsifiers include polysorbate 60 and polysorbate 80.

The gum or alginate helps control the rheological properties of the wetted edible paint during painting and use. Its shear thinning ability is used to control the flow and drip characteristics of the dissolved edible paint. It also acts as a stabilizer to inhibit separation of the starch and the water in the edible fluid medium. One preferred alginate is sodium alginate sold under the trade name KELCOLOID LVF™ by ISP Alginates, a division of International Specialty Products. Xanthan gum is one suitable alternative, although other gums and alginates may also be used.

The edible fluid media is mixed in a commercial size planetary mixer, such as a 140 qt. HOBART® mixer, as follows. Dry ingredient Nos. 1-4 (Table 1) are preferably first blended in the mixing bowl of the mixer for 5 minutes at low speed (speed setting #1). The water (ingredient No. 5) is divided into four equal portions. The citric acid (ingredient No. 6) is dissolved in a first one of the portions of the water; the potassium sorbate (ingredient No. 7) is dissolved in a second one of the portions of the water; and the sugar and humectant additive (ingredient Nos. 8 and 9) are dissolved in a third one of the portions of the water. The first, second, and third portions are added to the mixture of dry ingredients (Nos. 1-4), gradually increasing the speed of the mixer from low speed (speed setting #1) to a medium speed (speed setting #4) and mixing for 3 minutes. Next, the fourth portion of the water is added and the mixture is mixed for approximately 11 minutes at a medium speed setting #3 until well blended. The emulsifier (ingredient No.10) is then added to the mixture, which is further mixed for approximately 6 minutes at speed setting #3. The foregoing mixing steps are just one exemplary order and procedure for mixing the ingredients of an edible fluid medium, which may be varied. For example, in other embodiments, the ingredients may be mixed in a different sequence or all at once. Once mixed, the edible fluid medium may be used immediately to make edible fluid paints or stored in a closed container at room temperature for up to seven days.

One particular formulation for the edible fluid medium includes 39.0 kg tapioca starch, 6.0 kg corn syrup solids, 6.0 kg sugar, 1.5 kg instant CLEARGEL® modified waxy maize starch sold by National Starch Food Innovation, 0.2 kg sodium alginate, 40.7 kg water, 0.1 kg citric acid, 0.1 kg potassium sorbate, 5.8 kg glycerine, and 0.6 kg polyglycerol esters of fatty acids. Another formulation includes 20.4 kg tapioca starch, 11.3 kg MCC, 20.4 kg corn syrup solids, 0.2 kg sodium alginate, 36 kg water, 0.1 kg citric acid, 0.1 kg potassium sorbate, 3.6 kg invert sugar, 2.6 kg glycerine, and 0.9 kg polyglycerol esters of fatty acids. Still another formulation includes 10.0% sugar, 2.2% instant CLEARGEL®, 43.5% cold water, 0.1% citric acid, 0.1% potassium sorbate, 2.5% glycerine, 32.0% hot water (180° F.), 9.0% METHOCEL® E15 cellulose esters sold by Dow Chemical Company, and 0.6% polyglycerol esters of fatty acids.

The edible fluid medium may also include other formulations, such as formulations that are not water-based, for example, which may or may not be water-soluble. One such water-insoluble formulation includes an emulsion of fats or vegetable oils.

As indicated above, the edible fluid paints comprise a mixture of the edible fluid medium and edible colorants. The edible fluid medium is preferably formulated to be a diluent of the edible colorants to give a desired brilliance for painting and decoration, and to provide solids to the edible colorant, so when the edible fluid paints are dried on the carrier sheet they form solid shapes. In a preferred embodiment, an edible fluid paint includes between 90% and 96% of the edible fluid medium, between 4% and 5% of the edible colorant, and up to 5% added water. Edible fluid paints may be made by mixing the edible fluid medium and edible colorant in a mixer on low speed for 5 minutes, followed by optional mixing of added water for approximately 10 minutes while gradually increasing the speed to a medium speed (setting #3). The particular amount and type of edible colorants used depends on the desired hue of the edible paint.

The edible colorants are preferably water-soluble and may include water-soluble dyes, such as FD&C certified dye powders (certified by the U.S. Food and Drug Administration under the Food Drug & Cosmetics Act) and natural colors, that readily dissolve in the edible fluid medium. Natural colors may include vegetable colorants, such as cabbage extract and beet extract; fruit colorants, especially berry extracts, such as blackberry extract and blueberry extract, for example; saffron; turmeric; and various other colorants derived from plants and certain other living organisms. Alternatively, any other edible colorants suitable for human consumption may be used, including other food colors approved by a domestic or foreign government entity, including water-insoluble food colors, such as FD&C lakes. Water-soluble edible paints—referred to herein as edible watercolors—may be advantageously used to create decorations having a truly painterly appearance, including graduated hues and color values.

After the edible fluid paints have been mixed, they are deposited onto a common carrier substrate to result in spots 14 of the various hues and then dried until solid. The spots 14 may be deposited in any of a variety of ways, such as the screen casting technique described in the '394 patent, a stenciling method, fluid dropper, ink jet printing, offset printing, and other methods. For a screen casting method, the screen is preferably a food-compatible mesh material comprising woven nylon monofilament threads and a mesh count of between 15 and 255 openings per square inch, which results in a thickness of the dried (solid) edible paint of between about 10 and 200 microns. Other mesh counts and thicknesses may also be used and multiple layers of edible paint may be laid down (with intermediate drying or partial drying steps) to result in an overall thickness of the spots 14 of the solid edible paint 16 of between 10 and 500 microns, but preferably between 20 and 100 microns to help avoid waste when using palette 10 for most home decorating applications. The thickness and area of the spots 14 may be selected to provide the quantity of color necessary for the a desired number and type of project or projects. Spots 14 may also include layers of different colors to provide a dynamic decorating experience.

The deposited spots of edible fluid paints are preferably dried until consolidated and sufficiently firm to substantially withstand smearing or smudging during handling, but not so dry as to crack or disintegrate. Preferably, the spots 14 of dried edible paints will not melt at temperatures below 400° F. or readily peel or flake from carrier substrate 20. The dried edible paints preferably have a residual moisture content of between 6% and 10% by weight, and more preferably between 7% and 9% by weight, and most preferably about 8% by weight. Drying may be accomplished by air drying or heat drying, including infrared heating and heated forced air, and by other techniques. Solid edible paints according to some embodiments are expected meet the criteria of smear resistance defined below, while others are expected to meet the criteria of smudge resistance, also defined below. The solid edible paints may be said to “substantially withstand smearing” when they exhibit no noticeable smearing or transference after pressing a sheet of paper against the solid edible paints with approximately one pound of force per square inch, then removing the sheet of paper. A more stringent measure of “smudge resistance” involves use of a standard SUTHERLAND® rub testing machine (Danilee Co., San Antonio, Tex.) and a variant of the dry rub test defined by ASTM Test Standard F1571-95 (2002), in which a 2½-inch by 5½-inch test strip including a 1-inch diameter spot of the solid edible paint centered on a white carrier substrate must exhibit no noticeable smudge across the carrier substrate upon visual inspection with no magnification after exposing the test strip to ten rubs with a four pound test block covered with BUEHLER MICROCLOTH® (Buehler Ltd., Lake Bluff, Ill.) or equivalent.

To use the palette 10 of edible watercolors 12, a user wets one or more of the spots 14 of solid edible paint 16 to thereby dissolve at least a portion of the edible paint 16. Once the edible paint 16 has been dissolved or disintegrated into a suspension, the transfer applicator 24 is dipped into the wetted edible paint to thereby load the transfer applicator 24 with the edible paint and then rubbed or otherwise pressed against the article to be decorated. In preferred embodiments, an absorbent or water-carrying transfer applicator 24 such as a wetted brush, cotton swab, sponge, foam pad, cardboard, fingertip or other similar item is rubbed against one or more of the spots of solid edible paint 16 to dissolve the edible paint and load the transfer applicator 24 in one step, in the familiar and intuitive manner of a conventional watercolor set of the kind used by children. Alternatively, the spots 14 may each be wetted by dripping water or another solvent onto the spots 14 to thereby dissolve the spots 14 into small pools of edible paints, and thereafter a brush or other transfer applicator 24 may be dipped into or contacted to the wetted spots 14 for loading the transfer applicator 24. Other types of transfer applicators may also be used, such as stamps (a.k.a. rubber stamps), cotton balls, cosmetic pads, kitchen utensils, and virtually any other handheld implement. The surface of the transfer applicator 24 may not need be easily wettable or absorbent, as the emulsifiers in the edible paints 16 may help the dissolved edible paints to adhere to many kinds of transfer applicators 24. Furthermore, the terms “load” or “loaded” as used herein, do not require transfer applicator 24 to be fully loaded or saturated with edible paints. Rather, transfer applicator 24 can be said to be “loaded” when it carries at least some amount of edible paint and preferably an amount such that some of the edible paint is transferred to the surface of an article when the loaded transfer applicator 24 is contacted to or rubbed against the surface.

The water-soluble nature of edible watercolors 12 facilitates creation of personal and custom decorations and for creating a painterly appearance, having graduated hues, color values, intensities, and saturation. Edible watercolors and other edible paints within the scope of the disclosure may be used to decorate many kinds of articles, including food articles and non-food items, such as paper goods or dinner plates, for example. The edible watercolors 12 may be used by people of all ages without special skills, whereas traditional personalized cake decoration usually requires skill, special training, and/or special equipment. The ready-to-use palette 10 of solid edible paints facilitates decorating and minimizes spillage. The palette 10 preferably includes only a small amount of edible paint 16, and may be designed as a single-use product that can be discarded after a single decoration project. This configuration allows a fresh palette 10 to be used for each decoration project.

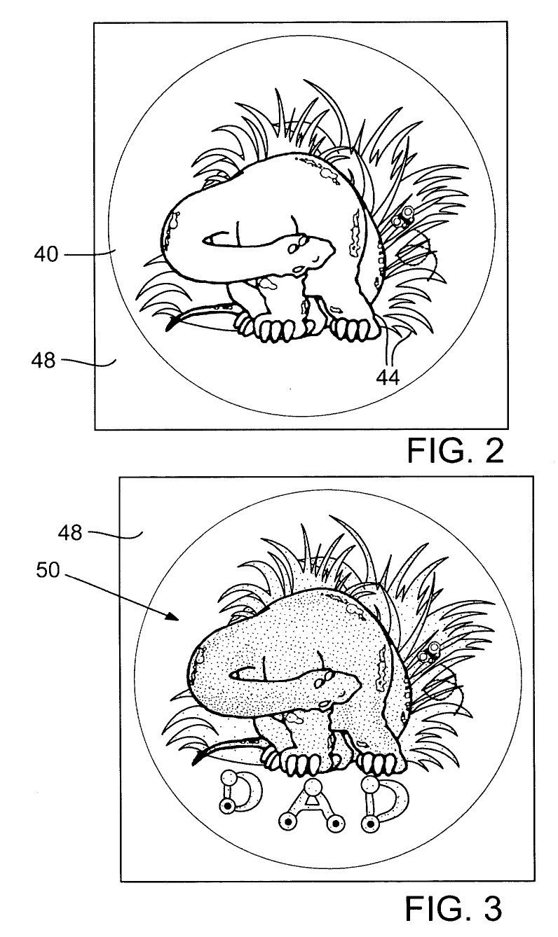

One particularly suitable “canvas” on which such edible decorations may be created is an edible decorating sheet of the kind described in the '394 patent and sold under the trade names EDIBLE IMAGE® and PRINT-ONS® by The Lucks Company of Seattle, Wash. Edible decorating sheets may also comprise other kinds of edible sheets or films, such as fondant or edible cellulose film, for example. Preferably, such edible decorating sheets should be blank or have limited markings pre-applied, to allow white area (or other pre-colored solid areas) to which edible paints may be readily applied to create an interesting edible decoration. One embodiment of an edible decorating sheet 40 is shown in FIG. 2, bearing a pre-printed picture outline 44 that helps define a picture for coloring, similar to a child's coloring book. Edible decorating sheets may also include textual and other graphical printing. Preferably such printing is formed of an edible colorant or ink composition that is water-insoluble or at least water-resistant, so as not to smear or bleed when edible watercolors are later applied. A preferred paint composition for pre-printed outlines comprises FD&C lakes suspended in an oil dispersion emulsified in a water-based medium or phase. Such outlines may have the added benefit of being hydrophobic, so as to shed the edible watercolors 12. Such oil-dispersed edible inks may also be used to pattern edible decorating sheet 40 with edible resists—i.e., areas of edible paint (typically white in color) that shed or resist the edible watercolors 12—resulting in designs, outlines and patterns when edible decorating sheet 40 is decorated with edible watercolors 12. Edible resists may blend in with the overall color of the edible decorating sheet 40 and may not be visible initially, but appear as distinct patterns or shapes after surrounding areas of the edible decorating sheet 40 are painted with edible watercolors 12.

Oil-disbursed inks and other water-insoluble inks may also be used on palettes 10 in combination with the water-soluble edible watercolors 12 to provide patterns on palettes 10 that last, even after spots 14 are dissolved or partially dissolved in water during use.

FIG. 3 shows the edible decorating sheet 40 of FIG. 2 after being decorated with edible watercolors 12. After applying edible watercolors 12 to the edible decorating sheets 40 to form a finished decoration 50 thereon, a flexible backing sheet 48 supporting the edible decorating sheet 40 may be peeled away. FIG. 4 depicts one suitable method of removing backing sheet 48 from the painted finished decoration 50, including dragging or rolling decorating sheet 40 and backing sheet 48 across the edge of a table or countertop. As shown in FIG. 5, the finished edible decoration 50 may then be applied to a food item, such as an iced cake 54 or cookie, for example. Other possible items having surfaces suitable for decoration using the edible decorations described herein include bread, tortillas, pies, ice cream cakes, cheesecake, cheese pizza, Easter eggs, three-dimensional edible food decorations (such as molded sugar decorations), and skin (body painting), for example. Many other items not enumerated here may also include surfaces suitable for decoration using the edible paints described herein.

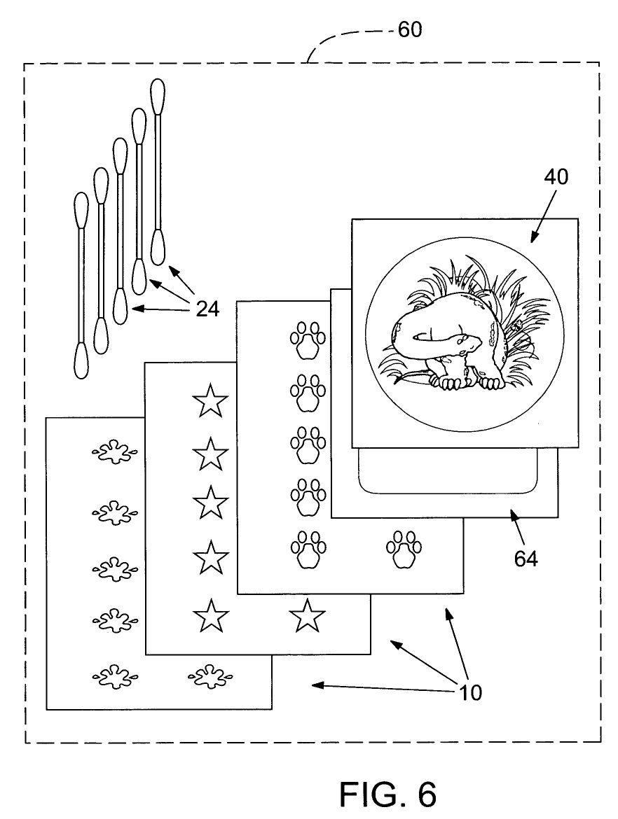

The palette 10 of solid edible paints 16 may be packaged as part of a kit, in a sealed bag or other container that preferably forms a moisture barrier around the kit. Suitable moisture barrier materials include metallized plastic, such as a metallized polyester bag with a resealable interlocking seal. So packaged, the palette 10 has an exceptionally good shelf-life of at least 6 months and preferably several years or more without requiring refrigeration, and can be opened, re-closed, and reopened several times during that period. FIG. 6 illustrates an exemplary decorating kit 60 that conveniently includes a plurality of transfer applicators 24, one or more palettes 10 of solid edible paints 16, and one or more edible decorating sheets 40. The edible decorating sheets 40 included in decorating kit 60 may include one or more blank edible decorating sheets 64 and/or pre-printed decorating sheets that are pre-printed with a picture outline or other design or text for enhancing the decorating experience.

As suggested by the title of this application, many of the embodiments described herein involve water-soluble paints. However, the scope of the disclosure is also intended to include water-insoluble paints. Thus, notwithstanding the suggestive term “watercolors” used in the title of this application, the scope of the claims should not be construed as being limited to water-soluble edible paints, unless specifically so indicated.

It will be obvious to those having skill in the art that many changes may be made to the details of the above-described embodiments without departing from their underlying principles. The scope of the present invention should, therefore, be determined only by the following claims.

1. A method of making an edible decoration, comprising:
(a) forming a palette including:
(i) mixing each of multiple amounts of an edible fluid medium with an edible colorant to produce a variety of edible fluid paints having different hues,
(ii) depositing spots of the edible fluid paints of different hues onto a carrier substrate, and
(iii) drying the spots of edible fluid paints until solid, thereby forming a set of solid edible paints on the carrier substrate;
(b) wetting at least a portion of the set of solid edible paints to thereby dissolve at least some of the solid edible paint on the carrier substrate;
(c) contacting a transfer applicator to the dissolved edible paint to thereby load the transfer applicator with edible paint; and
(d) contacting an article with the loaded transfer applicator to thereby make an edible decoration with the edible paint.

2. The method of claim 1 wherein the steps of dissolving at least a portion of the solid edible paint and loading the transfer applicator include rubbing a wetted transfer applicator against at least a portion of said solid edible paints.

3. The method of claim 1 wherein the forming of the palette further comprises dissolving the edible colorant in the edible fluid medium.

4. The method of claim 1 wherein the edible fluid medium is water-based.

5. The method of claim 1 wherein the edible colorant includes a dye.

6. The method of claim 1 wherein the drying of the spots of edible fluid paints includes drying the spots of edible fluid paints until they are firm enough to substantially withstand smearing.

7. The method of claim 1 wherein the spots of edible fluid paint are deposited on the carrier substrate by a screen casting technique.

8. The method of claim 1 wherein the transfer applicator is selected from the group consisting of: a sponge, a brush, a stamp, a swab, a cotton ball, a cosmetic pad, and a finger.

9. The method of claim 1, further comprising rubbing the loaded transfer applicator against an edible decorating sheet.

10. The method of claim 9 in which the edible decorating sheet is releasably adhered to a flexible backing sheet, and further comprising:
peeling the flexible backing sheet away from the edible decorating sheet; and
applying the edible decorating sheet onto a food item.

11. The method of claim 9 further comprising, in advance of making the edible decoration with the edible paint, printing a picture outline onto the edible decorating sheet using a water-resistant edible ink.

12. The method of claim 1, further comprising mixing a flavoring into each of the edible fluid paints.

13. The method of claim 1, further comprising mixing a scent additive into each of the edible fluid paints.

14. The method of claim 1 in which the drying of the spots includes drying the spots until they have a moisture content of between approximately 6% and 10% by weight.

15. A kit for use in making edible decorations, comprising:
a palette including:
a carrier substrate; and
a plurality of solid deposits of edible water-soluble paint of different hues arranged on the carrier substrate, each of the deposits of edible water-soluble paint including a mixture of an edible colorant and an edible medium, the mixture being readily soluble in water and paintable on an article using a wetted transfer applicator.

16. The kit of claim 15, wherein the solid deposits of edible water-soluble paint are sufficiently firm so as to substantially withstand smearing.

17. The kit of claim 15, further comprising a transfer applicator.

18. The kit of claim 15 in which each of the deposits of edible water-soluble paint further comprises a flavoring corresponding to its hue.

19. The kit of claim 15, further comprising an edible decorating sheet adapted to receive and carry an edible decoration created with the edible water-soluble paint.

20. The kit of claim 19 in which the edible decorating sheet is marked with an outline of a design.

21. The kit of claim 19 in which the edible decorating sheet includes markings made with a water-insoluble edible paint.

22. The kit of claim 19 which the edible decorating sheet is supported on a flexible backing sheet, the flexible backing sheet being peelable away from the edible decorating sheet so that the edible decorating sheet can be applied to a food item for consumption.

23. An edible watercolor, comprising solid water-soluble edible paint including a dried deposit of a fluid paint mixture including an edible fluid medium and a water-soluble edible colorant, the edible fluid medium including a humectant additive and a sugar, and the edible paint being soluble in water for painting onto an article using a transfer applicator.

24. The edible watercolor of claim 23 wherein the edible fluid medium further includes an emulsifier.

25. The edible watercolor of claim 23 wherein the dried deposit of the fluid paint mixture has a thickness of between 10 microns and 500 microns.

26. The edible watercolor of claim 23 wherein the dried deposit has a moisture content of between approximately 6% and approximately 10% by weight.
